(19) United States
(12) Patent Application Publication
(10) Pub. No.: US 2019/0287474 A1
(43) Pub. Date: Sep. 19, 2019

(54) LIQUID CRYSTAL DISPLAY DEVICE AND METHOD FOR PRODUCING LIQUID CRYSTAL DISPLAY DEVICE

(71) Applicant: SHARP KABUSHIKI KAISHA, Sakai City (JP)

(72) Inventor: SHINJI TOMOKAWA, Sakai City (JP)

(21) Appl. No.: 16/351,016

(22) Filed: Mar. 12, 2019

(30) Foreign Application Priority Data
Mar. 13, 2018 (JP) 2018-045852

(51) Int. Cl. G09G 3/36

(52) U.S. Cl. CPC G09G 3/3648; G09G 2320/0673; G09G 2320/0276

(57) ABSTRACT

To reduce display unevenness of a liquid crystal display panel, a liquid crystal display device includes (i) a liquid crystal display panel having a plurality of areas different from each other in the cell thickness and (ii) a driving section configured to carry out a gamma correction with respect to each of the plurality of areas in accordance with the applied voltage-transmittance characteristic that varies according to each of the plurality of areas.

This Nonprovisional application claims priority under U.S.C. § 119 on Patent Application No. 2018-045852 filed in Japan on Mar. 13, 2018, the entire contents of which are hereby incorporated by reference.

### TECHNICAL FIELD

The present invention relates to a liquid crystal display device and a method for producing a liquid crystal display device.

### BACKGROUND ART

A display panel including a liquid crystal module is designed so as to include a liquid crystal layer having a uniform cell thickness in a plane of the display panel.

Actual display panels, however, have the following issue: The cell thickness is not uniform in the plane of the display panel, and such a lack of uniformity is visible in the form of display unevenness. In particular, a portion of the display panel which portion surrounds an active area (AA) unfortunately causes peripheral unevenness due to a difference in height between spacers in the active area and those in the frame portion.

### CITATION LIST

### Patent Literature

[Patent Literature 1]

International Publication WO 2013058259

### SUMMARY OF INVENTION

### Technical Problem

The above issue is caused as follows: In a case where a display panel is designed, the height of each spacer in the active area and that of each spacer in the frame portion cannot be adjusted so as to be equal to each other, and the cell thickness at a central portion of the display panel and that at a peripheral portion of the display panel become different from each other as a result.

FIG. 3 provides diagrams each illustrating a liquid crystal display device 1a based on conventional art. (a) of FIG. 3 is a diagram illustrating the distribution of the cell thickness CT of the liquid crystal display device 1a. (b) of FIG. 3 is a cross-sectional view of a display panel 2, the view being taken along line A-A′. (b) of FIG. 3 is referred to also for description of embodiments of the present invention.

As illustrated in (a) of FIG. 3, the liquid crystal display device 1a includes a display panel 2 and a driving section 3a. The display panel 2 has an active area AA and a frame portion FP. The active area AA is an area of the display panel 2 which area is subject to a driving voltage applied by the driving section 3a and in which area an image is displayed. The frame portion FP corresponds to the frame of the display panel 2. The active area AA may have spacers SP1 that differ in height from spacers SP2 in the frame portion FP.

As illustrated in (b) of FIG. 3, the display panel 2 includes a stack of a first glass 21, a color filter 22, a liquid crystal layer 23, thin-film transistors (TFTs) 24, and a second glass 25. The liquid crystal layer 23 has spacers SP1 in the active area AA. The liquid crystal layer 23 has spacers SP2 and a sealing member SL in the frame portion FP. The cell thickness CT refers to the thickness of the liquid crystal layer 23, that is, the distance between the color filter 22 and the TFTs 24.

Peripheral unevenness results from the cell thickness CT of the display panel 2 varying between a central area CA and a peripheral area PA in the active area AA. Specifically, the conditions for forming the first glass 21 as a color filter (CF) glass and the conditions for forming the second glass 21 as a TFT glass differ between the active area AA and the area outside the active area AA. This requires optimizing (i) the height of the spacers SP1 in the active area AA, (ii) the height of the spacers SP2 in the area outside the active area AA, and (iii) the conditions for forming the sealing member SL. However, factors such as variations during the production process cause a difference in the cell thickness CT between the central area CA and the peripheral area PA in the active area AA, and thereby cause peripheral unevenness.

An aspect of the present invention has an object of reducing display unevenness of a liquid crystal display panel.

### Solution to Problem

In order to attain the above object, a liquid crystal display device in accordance with an aspect of the present invention includes: a liquid crystal display panel having a plurality of areas different from each other in terms of a cell thickness; and a driving section configured to carry out a gamma correction with respect to each of the plurality of areas in accordance with an applied voltage-transmittance characteristic that varies according to each of the plurality of areas.

In order to attain the above object, a method in accordance with an aspect of the present invention for producing a liquid crystal display device includes: adjusting a driving section of the liquid crystal display device so that the driving section carries out a gamma correction with respect to each of a plurality of areas of a liquid crystal display panel, which plurality of areas are different from each other in terms of a cell thickness, in accordance with an applied voltage-transmittance characteristic that varies according to each of the plurality of areas.

### Advantageous Effects of Invention

An aspect of the present invention can reduce display unevenness of a liquid crystal display panel.

### BRIEF DESCRIPTION OF DRAWINGS

FIG. 1 provides diagrams each illustrating an aspect of a liquid crystal display device according to Embodiment 1 of the present invention, where (a) illustrates a single gamma correction, (b) illustrates the applied voltage-transmittance characteristic of a display panel, and (c) illustrates a gamma correction for a central area and a gamma correction for a peripheral area.

FIG. 2 provides diagrams each illustrating the configuration of a liquid crystal display device according to Embodiment 2 of the present invention, where (a) illustrates a single gamma correction, (b) illustrates a gamma correction for an area having no unevenness and a gamma correction for an area having unevenness.

FIG. 3 provides diagrams each illustrating a liquid crystal display device based on conventional art, where (a) is a diagram illustrating the distribution of the cell thickness of the liquid crystal display device, and (b) is a cross-sectional view of a display panel, the view being taken along line A-A′.

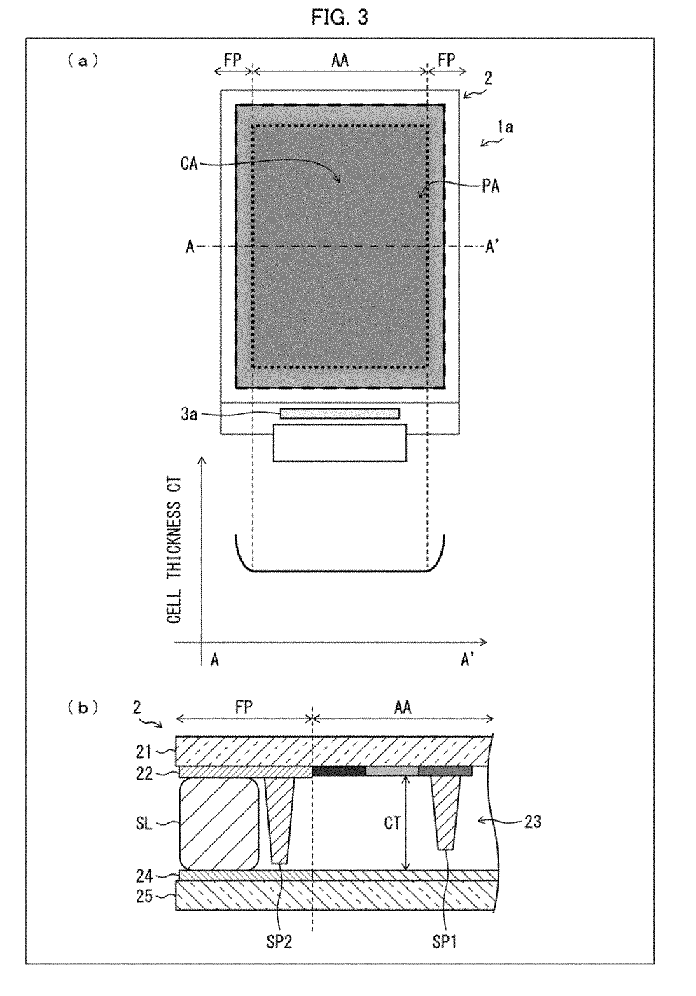

### DESCRIPTION OF EMBODIMENTS

### Embodiment 1

The following description will discuss Embodiment 1 of the present invention in detail.

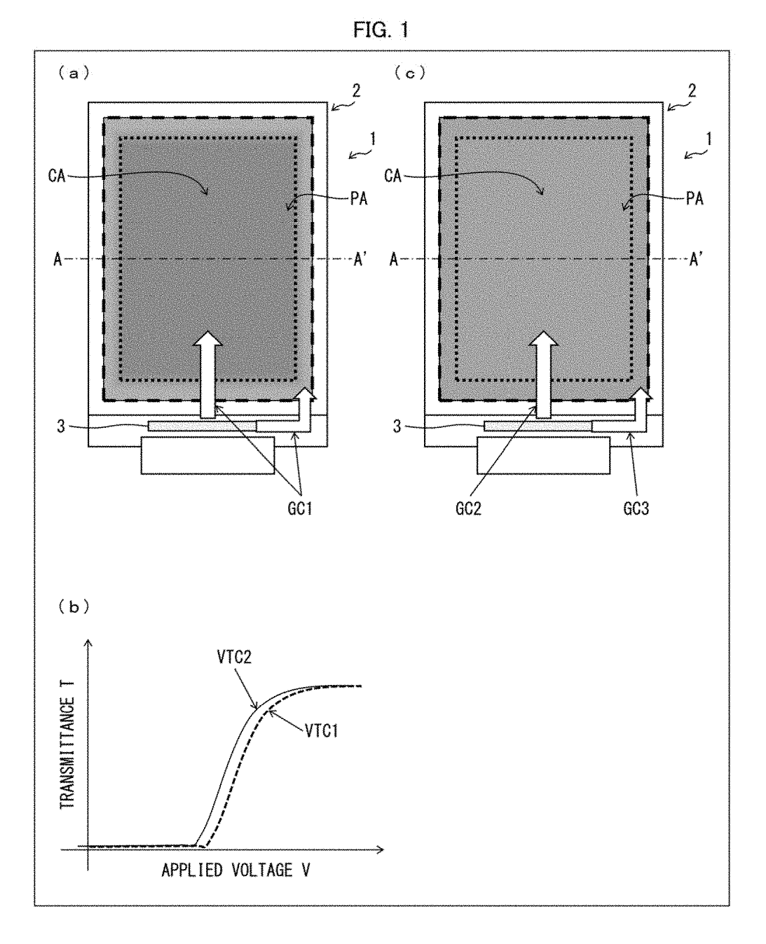

FIG. 1 provides diagrams each illustrating an aspect of a liquid crystal display device 1 according to the present embodiment. (a) of FIG. 1 illustrates a single gamma correction GC1. (b) of FIG. 1 illustrates the applied voltage-transmittance characteristic of a display panel 2. (c) of FIG. 1 illustrates a gamma correction GC2 for a central area and a gamma correction GC3 for a peripheral area.

The liquid crystal display device 1 according to the present embodiment includes (i) a display panel 2 as a liquid crystal display panel which display panel 2 has a plurality of areas different from each other in terms of the cell thickness CT and (ii) a driving section 3 configured to carry out a gamma correction with respect to each of the plurality of areas in accordance with the applied voltage-transmittance characteristic that varies according to each of the plurality of areas. The driving section 3 is an integrated circuit (IC) for driving the display panel 2. The driving section 3 of the liquid crystal display device 1 may be configured to carry out a gamma correction with respect to each of the plurality of areas in accordance with the applied voltage-transmittance characteristic corresponding to the cell thickness CT of that area. The plurality of areas may include a central area CA and a peripheral area PA in an active area AA of the display panel 2.

In a case where the cell thickness CT is uniform between the central area CA and the peripheral area PA in the active area AA, and thus no unevenness is caused, the driving section 3 carries out a single gamma correction GC1 as illustrated in (a) of FIG. 1.

In a case where the cell thickness CT varies between the central area CA and the peripheral area PA in the active area AA, the V-T curve (which indicates the applied voltage-transmittance characteristic) differs between the central area CA and the peripheral area PA. In other words, the V-T curve VTC1 for the central area CA and the V-T curve VTC2 for the peripheral area PA differ from each other as illustrated in (b) of FIG. 1. Thus, if the driving section 3 applies the same voltage to the entire active area AA of the display panel 2, the central area CA and the peripheral area PA will differ from each other in luminance.

Such a luminance difference is more noticeable in halftones.

In view of that, the driving section 3 of the liquid crystal display device 1 is configured to carry out respective gamma corrections separately for the central area CA and the peripheral area PA as the plurality of areas in the active area AA of the display panel 2. In other words, as illustrated in (c) of FIG. 1, the driving section 3 is configured to carry out a gamma correction GC2 for the central area CA and a gamma correction GC3 for the peripheral area PA.

Specifically, the driving section 3 stores a gamma table that includes (i) a gamma correction value for an area of the active area AA which area has a small cell thickness CT and (ii) a gamma correction value for an area of the active area AA which area has a large cell thickness CT. The driving section 3 also stores a gamma table that includes a gamma correction value for an area having unevenness. The driving section 3 selects a gamma table in accordance with (i) the cell thickness of the target area and (ii) the presence or absence of unevenness, and carries out a gamma correction of the target area with use of a gamma correction value included in the gamma table selected.

The cell thickness of the target area and the presence or absence of unevenness may be determined by visual inspection or by measurement and determination based on (i) image acquisition involving use of an image sensing device and (ii) image recognition involving use of an image processing device.

### Effects of Embodiment 1

The applied voltage-transmittance characteristic may vary between the central area CA and the peripheral area PA of the active area AA due to a difference in the cell thickness CT. Embodiment 1 of the present invention is configured such that the driving section 3 carries out respective gamma corrections separately for the central area CA and the peripheral area PA (between which the applied voltage-transmittance characteristic differs). This makes it possible to reduce peripheral unevenness of the display panel 2.

Conventional driver ICs (driving sections) are configured to carry out image display on the basis of a single gamma setting for the entire display panel. Thus, a display panel having areas that differ from each other in the cell thickness CT causes unevenness and is defective.

The present embodiment is configured such that the driver IC carries out not only a single gamma setting but also respective gamma settings for different areas of the display panel 2. Thus, a display panel 2 having areas that differ from each other in the cell thickness CT has reduced unevenness and is not defective.

### Embodiment 2

The following description will discuss Embodiment 2 of the present invention. For convenience of explanation, any member of the present embodiment that is identical in function to a member described for the embodiment above is assigned the same reference sign. Such a member is not described again here.

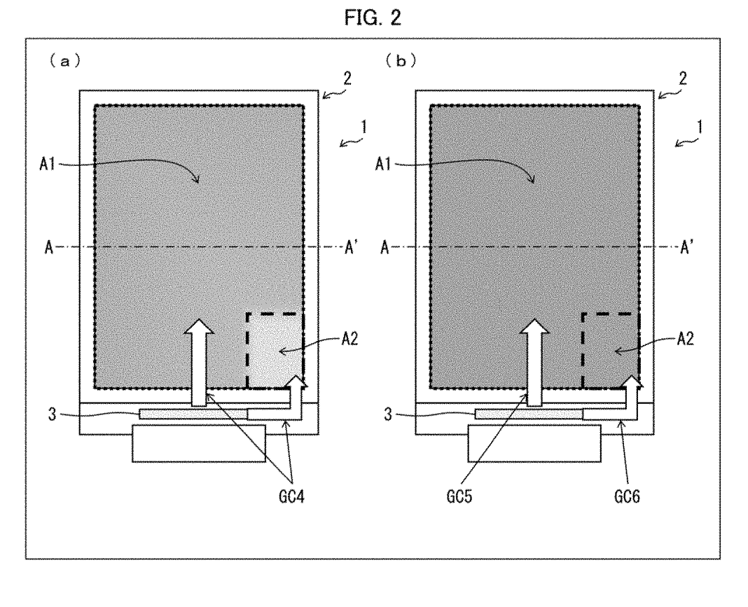

FIG. 2 provides diagrams each illustrating the configuration of a liquid crystal display device 1 according to the present embodiment. (a) of FIG. 2 illustrates a single gamma correction GC4. (b) of FIG. 2 illustrates a gamma correction GC5 for an area having no unevenness and a gamma correction GC6 for an area having unevenness.

As illustrated in (a) of FIG. 2, in a case where the cell thickness CT is uniform between a partial area A1 in the active area AA and an area A2 in the active area AA which area A2 is other than the area A1, and thus no unevenness is caused, the driving section 3 carries out a single gamma correction GC4.

In a case where the cell thickness CT varies between the area A1 and the area A2 in the active area AA, the V-T curve (which indicates the applied voltage-transmittance characteristic) differs between the area A1 and the area A2. Thus, if the driving section 3 applies the same voltage to the display panel 2, the area A1 and the area A2 will differ from each other in luminance. This will cause an area having no unevenness and an area having unevenness to be visible.

In view of that, the driving section 3 of the liquid crystal display device 1 is configured to, as illustrated in (b) of FIG. 2, carry out respective gamma corrections GC5 and GC6 separately for the areas A1 and A2 as a plurality of areas of the display panel 2.

### Effects of Embodiment 2

Embodiment 2 of the present invention allows a gamma correction area as an area having unevenness other than peripheral unevenness to be set as appropriate in the active area AA, and can thereby reduce local unevenness.

### Embodiment 3

The following description will discuss Embodiment 3 of the present invention. For convenience of explanation, any member of the present embodiment that is identical in function to a member described for the embodiments above is assigned the same reference sign. Such a member is not described again here.

A method for producing the liquid crystal display device 1 includes adjusting the driving section 3 of the liquid crystal display device 1 so that the driving section 3 carries out a gamma correction with respect to each of a plurality of areas of the display panel 2 as a liquid crystal display panel, which plurality of areas are different from each other in terms of the cell thickness CT, in accordance with the applied voltage-transmittance characteristic that varies according to each of the plurality of areas. The presence or absence of unevenness in the active area AA is checked, and in a case where the active area AA has unevenness, the driving section 3 is adjusted. The presence or absence of unevenness may be determined by visual inspection or by determination based on (i) image acquisition involving use of an image sensing device and (ii) image recognition involving use of an image processing device.

A method for producing the liquid crystal display device 1 may include adjusting the driving section 3 so that the driving section 3 carries out a gamma correction with respect to each of the plurality of areas in accordance with the applied voltage-transmittance characteristic corresponding to the cell thickness of that area. The plurality of areas may include a central area CA and a peripheral area PA in an active area AA of the display panel 2.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### [First Aspect]

A liquid crystal display device, including: a liquid crystal display panel having a plurality of areas different from each other in terms of a cell thickness; and a driving section configured to carry out a gamma correction with respect to each of the plurality of areas in accordance with an applied voltage-transmittance characteristic that varies according to each of the plurality of areas.

### [Second Aspect]

The liquid crystal display device according to, for example, the first aspect, wherein the driving section carries out the gamma correction with respect to each of the plurality of areas in accordance with the applied voltage-transmittance characteristic corresponding to the cell thickness of the area.

### [Third Aspect]

The liquid crystal display device according to, for example, the first or second aspect, wherein the plurality of areas include a central area and a peripheral area of the liquid crystal display panel.

### [Fourth Aspect]

A method for producing a liquid crystal display device, the method including: adjusting a driving section of the liquid crystal display device so that the driving section carries out a gamma correction with respect to each of a plurality of areas of a liquid crystal display panel, which plurality of areas are different from each other in terms of a cell thickness, in accordance with an applied voltage-transmittance characteristic that varies according to each of the plurality of areas.

### [Fifth Aspect]

The method according to the fourth aspect, wherein the driving section is adjusted so as to carry out the gamma correction with respect to each of the plurality of areas in accordance with the applied voltage-transmittance characteristic corresponding to the cell thickness of the area.

### [Sixth Aspect]

The method according to, for example, the fourth or fifth aspect, wherein the plurality of areas include a central area and a peripheral area of the liquid crystal display panel.

### REFERENCE SIGNS LIST

1 Liquid crystal display device
2 Display panel
3 Driving section

1. A liquid crystal display device, comprising:
a liquid crystal display panel having a plurality of areas different from each other in terms of a cell thickness; and
a driving section configured to carry out a gamma correction with respect to each of the plurality of areas in accordance with an applied voltage-transmittance characteristic that varies according to each of the plurality of areas.

2. The liquid crystal display device according to claim 1, wherein
the driving section carries out the gamma correction with respect to each of the plurality of areas in accordance with the applied voltage-transmittance characteristic corresponding to the cell thickness of the area.

3. The liquid crystal display device according to claim 1, wherein
the plurality of areas include a central area and a peripheral area of the liquid crystal display panel.

4. A method for producing a liquid crystal display device, the method comprising:
adjusting a driving section of the liquid crystal display device so that the driving section carries out a gamma correction with respect to each of a plurality of areas of a liquid crystal display panel, which plurality of areas are different from each other in terms of a cell thickness, in accordance with an applied voltage-transmittance characteristic that varies according to each of the plurality of areas.

5. The method according to claim 4, wherein
the driving section is adjusted so as to carry out the gamma correction with respect to each of the plurality of areas in accordance with the applied voltage-transmittance characteristic corresponding to the cell thickness of the area.

6. The method according to claim 4, wherein
the plurality of areas include a central area and a peripheral area of the liquid crystal display panel.
